(19) United States
(12) Patent Application Publication
(10) Pub. No.: US 2015/0325334 A1
(43) Pub. Date: Nov. 12, 2015

(54) POWER UMBILICAL

(71) Applicant: TECHNIP FRANCE, Courbevoie (FR)

(72) Inventors: James Michael ZERKUS, Seabrook, TX (US); Dave ROBSON, League City, TX (US); Stephanie ROBERTS, Houston, TX (US); Geoff Moody, Katy, TX (US)

(73) Assignee: TECHNIP FRANCE, Courbevoie (FR)

(21) Appl. No.: 14/272,229

(22) Filed: May 7, 2014

(51) Int. Cl. H01B 7/14; H02G 15/02; H01B 9/00

(52) U.S. Cl. CPC H01B 7/14; H01B 9/006; H02G 15/02

(57) ABSTRACT

The present invention relates to an umbilical 10 comprising a first independent 3-phase power supply circuit 14, the 3-phase power supply circuit 14 comprising at least six power cables 12 wherein each phase R, T, S of the 3-phase power supply circuit 14 consists of at least two power cables 12 connected in parallel with each other.

The present invention relates to a power umbilical or a subsea power cable, in particular one that is used in an offshore application such as oil and gas field developments, subsea pumping, processing and renewable energy installations.

### BACKGROUND TO THE INVENTION

An umbilical consists of a group of one or more types of elongated active umbilical elements, such as electrical cables, optical fiber cables, steel pipes and/or hoses, cabled together for flexibility, over-sheathed and, when applicable, armored for mechanical strength.

Umbilicals are typically used for transmitting power, signals and fluids (for example for fluid injection, hydraulic power, gas release, etc.) to and from a subsea installation.

The umbilical cross-section is generally circular. The elongated elements of the umbilical are wound together either in a helical or in a S/Z pattern. In order to fill the interstitial voids between the various umbilical elements and obtain the desired configuration for the umbilical, filler components may be included within the voids.

ISO 13628-5/API (American Petroleum Institute) 17E “Specification for Subsea Umbilicals”, provides standards for the design and manufacture of such umbilicals.

Subsea umbilicals are installed at increasing water depths, commonly deeper than 2000 m. Such umbilicals have to be able to withstand severe loading conditions during their installation and their service life.

The main load bearing components in use for withstanding the axial loads due to the weight and to the movements of the umbilical are steel pipes (see U.S. Pat. No. 6,472,614, WO93/17176 and GB2316990), steel rods (see U.S. Pat. No. 6,472,614), composite rods (see WO2005/124213), tensile armor layers (see FIG. 1 of U.S. Pat. No. 6,472,614), or steel wire ropes.

The other elements of the umbilical, i.e. the electrical and optical cables, the thermoplastic hoses, the polymeric external sheath and the polymeric filler components etc., do not contribute significantly to the tensile strength of the umbilical.

Electrical cables used in subsea umbilicals fall into two distinct categories respectively known as power cables and signal cables.

Power cables are used for transmitting high electrical power (typically a few MW) to powerful subsea equipment such as pumps. Power cables are rated at voltages comprised between 1 kV and 200 kV, and generally between 6kV and 35kV (medium voltage range).

A typical power cable is illustrated in FIG. 1. From inside outside, it comprises a central copper conductor 2a, semi-conductor and electrical insulation layers 2b, a metallic foil screen 2c and an external polymeric sheath 2d.

The central conductor 2a has generally a stranded construction and a large section typically comprised between 50 mm² and 400 mm². Three phase AC power is provided by three such cables typically bundled together within the umbilical structure.

Signal cables are generally used for transmitting signals and low power (<1 kW) to electrical devices on the seabed. Signal cables are generally rated at a voltage smaller than 1000V.

Signal cables generally consist of small section insulated conductors bundled together as pairs (2), quads (4) or, very rarely, any other number, said bundle being further over-sheathed.

An example of quad signal cable is illustrated in FIG. 2. Four small size stranded copper conductors 3a are individually over sheathed by polymeric insulation layers 3b and helically bundled together. A polymeric filler material 3c is added to fill the voids in the bundle and achieve a cylindrical shape. This arrangement is optionally surrounded by an electric field shielding 3g made from a wrapped copper or aluminium foil. A polymeric external sheath 3d protects the cable against mechanical damage and water ingress. These cables are sometimes filled with a water blocking compound that swells on contact with water so as to block water travelling along the cable if the outer jacket is breached.

An umbilical comprising at least one power cable is called a power umbilical. WO2005/124213 discloses an example of a power umbilical. The power umbilicals shown on the figures of WO2005/124213 comprise two independent 3-phase power supply circuits. Each 3-phase power supply circuit is defined by three power cables representing each phase of the power supply circuit.

There is an ever increasing drive to work at greater water depths, certainly beyond 1000 metres, and now commonly in excess of 2000 metres or even 3000 metres. As a result, there is a need in the oil & gas market to increase the length of the umbilicals and to also increase the amount of power to be transmitted to subsea equipment.

Increasing the length of the umbilical and the amount of power to be transmitted generally involves increasing the size of the copper conductors and hence the size of the power cables. However, this can result in umbilicals having a very large diameter and increased weight as a result

There is therefore a need to increase the current carrying capability of power cables (i.e. ampacity of the power cables) in an umbilical without increasing the cross-section of the conductors, as increasing the cross-section of the conductors would increase the weight, the dimensions and the cost of the umbilical.

### SUMMARY OF THE INVENTION

In accordance with a first aspect, there is provided an umbilical comprising a first independent 3-phase power supply circuit, the power supply circuit comprising at least six power cables wherein each phase of the 3-phase power supply circuit consists of at least two power cables connected in parallel with each other.

The present invention facilitates the increase of the current carrying capability of the power cables without increasing the cross-section of the conductors.

The present invention also reduces the electrical power losses in a power umbilical, in particular umbilicals used to transmit 3-phase alternative currents.

The umbilical in accordance with the invention may further comprise a second independent 3-phase power supply circuit.

In exemplary embodiments having a second independent 3-phase power supply circuit, the second 3-phase power supply circuit may comprise at least six power cables wherein each phase of the second 3-phase power supply circuit consists of at least two power cables connected in parallel with each other.

In exemplary embodiments, the umbilical comprises three or more independent 3-phase power supply circuits. Each 3-phase independent power supply circuit may comprise at least six power cables wherein each phase of the 3-phase power supply circuit consists of at least two power cables connected in parallel with each other.

In exemplary embodiments, three of the at least six power cables are bundled together in triplex formation for power distribution to form a power cable triad. All of the power cables may be bundled together in triplex formation for power distribution to form power cable triads.

In exemplary embodiments wherein the power cables are bundled together in triplex formation to form a power cable triad, the umbilical may comprise at least three power cable triads defining the first independent 3-phase power supply circuit.

In exemplary embodiments comprising more than one independent 3-phase power supply circuit, one of or each independent 3-phase power supply circuit may comprise at least three power cable triads.

In exemplary embodiments wherein the power cables are bundled together in triplex formation to form a power cable triad, each triad may consist of 3 insulated power cables twisted together.

In exemplary embodiments having a plurality of power cable triads, the power cable triads may be symmetrically arranged within the umbilical. The power cable triads may be arranged symmetrically in the umbilical cross-section. For example, the power cable triads defining at least one independent 3-phase power supply circuit may be arranged at regular angular intervals along an imaginary circle centered on a main longitudinal axis of the umbilical. The power cable triads defining each independent 3-phase power supply circuit may be arranged at regular angular intervals along an imaginary circle centered on a main longitudinal axis of the umbilical.

In exemplary embodiments having two or more independent 3-phase power supply circuits, the first and second independent 3-phase power supply circuits may be arranged so as to define an outer circuit and an inner circuit within the umbilical. The outer circuit and the inner circuit may be contra-helically laid.

In exemplary embodiments, the power cables may be connected in parallel in at least one termination of the umbilical. The power cables may be connected in parallel in both terminations of the umbilical.

In alternative exemplary embodiments, the power cables may be connected in parallel outside both terminations of the umbilical.

Preferably, the umbilical is a subsea power umbilical.

### BRIEF DESCRIPTION OF THE DRAWINGS

The invention will now be described by way of non-limiting example, with reference being made to the accompanying drawings, in which:

FIG. 1 comprises cross-section and perspective views of a typical power cable;

FIG. 2 comprises cross-section and perspective views of a typical signal cable;

FIGS. 3A and 3B are cross-section and schematic views showing the arrangement of the power cables in a first embodiment of an umbilical in accordance with the invention;

FIG. 4 is a schematic view showing an alternative arrangement of the power cables in an umbilical in accordance with a first embodiment of the invention;

FIGS. 5a and 5b are cross-section and schematic views showing an arrangement of the power cables in a second embodiment of an umbilical in accordance with the invention;

FIGS. 6a and 6b are schematic views showing alternative arrangements of the power cables in an umbilical in accordance with a second embodiment of the invention;

FIG. 7 is a cross-sectional view of an umbilical in accordance with a second embodiment of the invention showing an arrangement of the umbilical elements contained therein;

FIG. 8 depicts a 3-phase power supply circuit diagram of the umbilical of FIG. 7 showing the connections of power cables in the circuit;

FIG. 9 depicts a 3-phase power supply circuit diagram of the umbilical of FIG. 7 showing an alternative embodiment of the connection of the power cables in the circuit;

FIGS. 10a and 10b are schematic views showing arrangements of the power cables in an umbilical in accordance with a third embodiment of the invention;

FIG. 11 is a schematic view showing an arrangement of the power cables in an umbilical in accordance with a fourth embodiment of the invention;

FIG. 12 is a cross-sectional view showing an arrangement of the power cables in an umbilical in accordance with a fifth embodiment of the invention;

FIG. 13 is a cross-sectional view showing an alternative arrangement of the power cables in an umbilical in accordance with the fifth embodiment of the invention; and

FIG. 14 depicts a 2-part 3-phase power supply circuit diagram of the umbilical in accordance with the fifth embodiment of the invention.

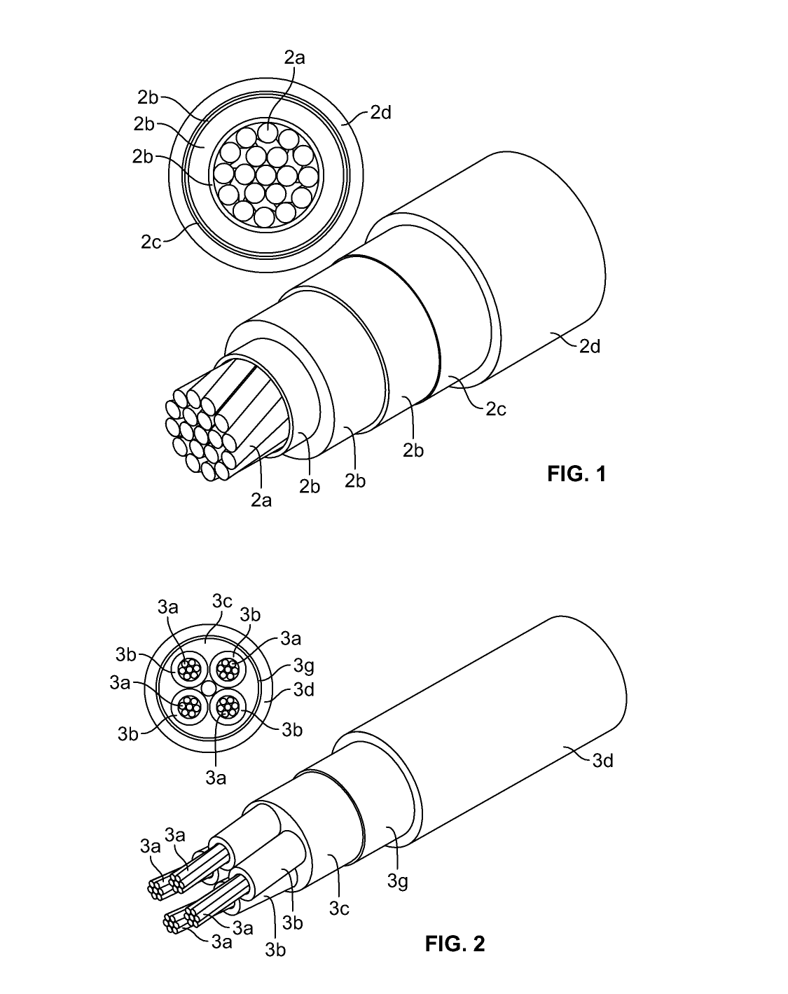

### DESCRIPTION OF THE PREFERRED EMBODIMENTS

The preceding discussion of the background to the invention is intended only to facilitate an understanding of the present invention. It should be appreciated that the discussion is not an acknowledgement or admission that any of the material referred to was part of the common general knowledge as at the priority date of the application.

Throughout the description and claims of this specification, the words “comprise” and “contain” and variations of the words, for example “comprising” and “comprises”, mean “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, compounds described in conjunction with a particular aspect, embodiment or example of the invention are to be understood to be applicable to any other aspect, embodiment or example described herein unless incompatible therewith.

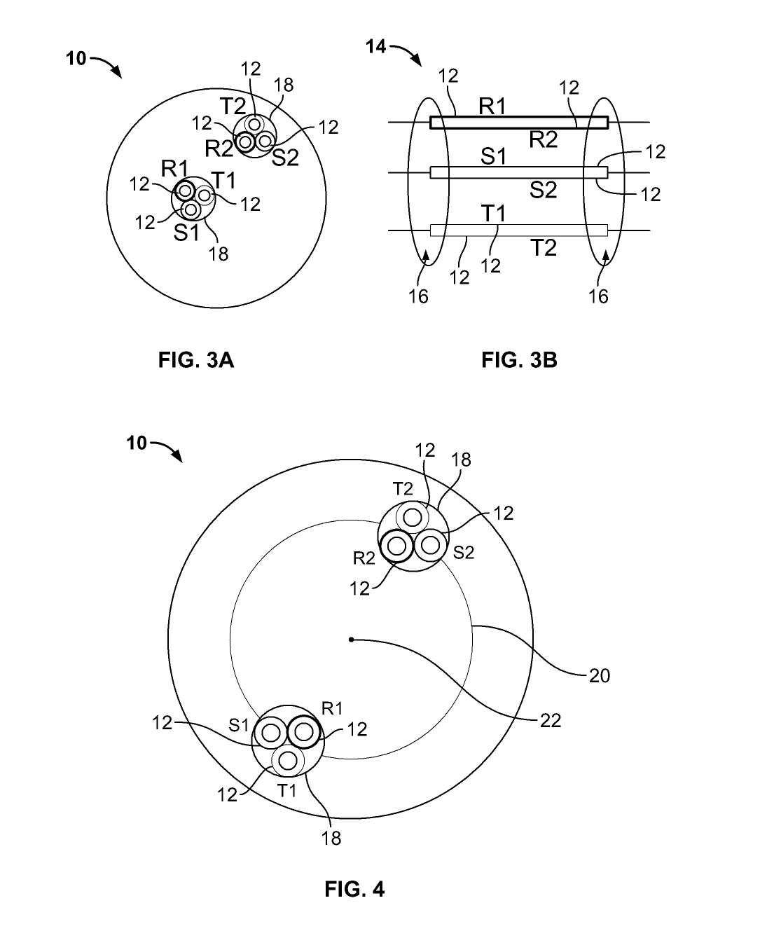

Referring to FIG. 3, a first embodiment of an umbilical 10 in accordance with the invention is shown depicting the arrangement of the power cables 12 therein. Only the power cables 12 are shown for clarity. The umbilical 10 is in the form of a subsea power umbilical.

The umbilical 10 comprises a first independent 3-phase power supply circuit 14 (see FIG. 3b). The power supply circuit 14 comprises at least six power cables 12 and each phase R, S, T of the 3-phase power supply circuit consists of at least two power cables 12 connected in parallel with each other.

In the embodiment shown, the 3-phase power supply circuit 14 comprises six power cables 12 with each phase R, S, T consisting of two power cables 12 connected in parallel with each other. The power cables 12 are connected in parallel within the terminations 16 of the umbilical 10.

While the power cables 12 have been shown to be connected in parallel at both ends within the terminations 16 of the umbilical 10, it is not essential for the power cables 12 to be connected within the terminations 16 of the umbilical 10. For example, the power cables 12 may be connected in parallel in only one termination 16 of the umbilical 10 or be connected in parallel outside both terminations of the umbilical 10.

In the arrangement shown, the power cables 12 are bundled together in triplex formation for power distribution to form power cable triads 18. Such an arrangement reduces the reactive power losses. It also reduces the inductive couplings to other components of the umbilical.

As shown in FIG. 3a, with six power cables 12, two power cable triads 18 are formed. The first power cable triad 18 comprises three phases R1, S1, T1 and the second power cable triad 18 comprises three phases R2, S2, T2.

Each power cable triad 18 consists of three insulated power cables 12 twisted together. While all six power cables 12 are depicted bundled together in triplex formation to form power cable triads, it would be understood that it is not essential for all or any of the power cables to be bundled together. None of the cables may be bundled together or just three of the six power cables may be bundled together in triplex formation for power distribution to form a power cable triad. However, the embodiments wherein all the power cables are bundled in triplex formation are preferred because they more efficiently reduce the reactive power losses.

Currently in known subsea umbilicals, a single triad is utilised for each 3-phase power supply circuit. Accordingly, an umbilical having two triads as shown in FIG. 3 would be used to drive 3-phase power supply to two independent equipment (i.e. submarine pumps, compressors, etc.) in known subsea umbilicals.

One of the losses which reduce the ampacity of the power cables is notably related to the “skin effect” which concentrates the currents close to the surface of the conductors of the power cables, thus reducing the current density in the central part of the conductors. This effect depends on the frequency of the alternative current. The higher the frequency, the smaller the depth of penetration of the currents within the conductor. When the operational frequency is larger than 200 Hz (power supply of some submarine compressors) the skin effect significantly reduces the ampacity of the power cables.

When the umbilical comprises many power cables, their ampacity can also be reduced by the “proximity effect”. The proximity effect in a conductor is caused by the magnetic field of neighbour cables and tends to “push” the current flow lines into a certain part of the conductor, thus also reducing the useful conductor cross-section.

An umbilical 10 in accordance with the invention avoids the use of large conductors and replaces them by several smaller individually insulated conductors connected in parallel. Indeed, due to the skin effect, the current flow line is concentrated close to the surface of the conductor. The thickness T of the surface layer where the current flow lines are concentrated can be estimated with the formula below:

$$T \approx \frac{1}{\sqrt{πμσ F}}$$

μ is the magnetic permability of the conductor, σ is the electrical conductivity of the conductor, and F is the frequency of the alternative current transported by the conductor.

For a copper conductor: μ=4π 10⁻⁷ H/m and σ=5.95 10⁷ S/m

Therefore, for a copper conductor:

Frequency F (Hz)

| | 50 | 60 | 100 | 200 |
|---|---|---|---|---|
| Thickness T (mm) | 9.2 | 8.4 | 6.5 | 4.6 |

The conductor cross-section is generally circular. Let us call R the radius of this circle.

If T is much small than R, then a large part of the cross section of the conductor is not used to transmit the current, which decreases the ampacity. T should ideally be equal or greater than R so that the whole cross-section is used for the current transmission.

If we assume that R should not be higher than T, then we can deduce the size of the ideal conductors:

| | Frequency F (Hz) | | |
|---|---|---|---|
| | 50 | 100 | 200 |
| Conductor radius R (mm) | 9.2 | 6.5 | 4.6 |
| Conductor section (mm²) | 265.9 | 132.7 | 66.5 |

Therefore, in order to reduce the losses, each conductor should have a section smaller than a maximum value which depends on the frequency.

For the most demanding applications (deep water, very long umbilical), the section of each conductor should be smaller than 70 mm², preferably around 50 mm² (smallest power cables used in subsea umbilical, the whole section range extending from around 50 mm² to around 400 mm²).

The way the different conductors are bundled and positioned within the umbilical makes it possible to further reduce the losses. The bundling of the power cables in triads results in lower losses than if the power cables were not arranged in triads.

Indeed, a triad has the advantage of not generating an important magnetic field when it is used to transmit 3-phase AC currents. Indeed, the 3 magnetic field generated by the three cables of the triad almost compensate each other (sum of the 3 fields close to zero) because first the three conductors are very close to each other, and second the sum of the 3 currents transmitted by the three conductors is equal to zero at any point in time (property of 3-phase currents).

In addition, the proximity effect from adjacent groups of conductors is reduced when these groups are arranged in triads. This advantage also reduces the interferences both between power circuits and between power and signal cables. This can be a major issue in long umbilical containing multiple power circuits, each operating at different frequencies between 25 Hz and 200 Hz.

The insulation level of the individual power conductors, the spacing between the power conductors within the triads and the number of triads in parallel are all specifically chosen to achieve a specific electrical impedance of the overall power path.

According to a preferred embodiment, the power cable triads 18 used to form an independent 3-phase power supply circuit are identical to each other, which means that the power cables 12 connected in parallel are also identical to each other. The impedances of the three parallel circuits are thus almost equal, which ensures that the 3-phase electrical power is not distorted during its transmission along the umbilical. Asymmetric loading (voltage asymmetry) is thus avoided.

Referring to FIG. 4, an alternative arrangement of the power cables 12 in an umbilical 10 in accordance with the first embodiment of the invention is shown.

As in the earlier described embodiment, the umbilical comprises six power cables 12 bundled together to form two power cable triads 18. The arrangement of FIG. 4 differs from that of FIG. 3 in that the triads 18, and hence the power cables 12, are symmetrically arranged within the umbilical 10.

The triads 18 are preferably arranged symmetrically in the umbilical cross-section. In the depicted arrangement, the triads 18 are arranged at regular angular intervals along an imaginary circle 20 centered on a main longitudinal axis 22 of the umbilical 10.

This has the effect of further improving the ampacity and reduces the interferences.

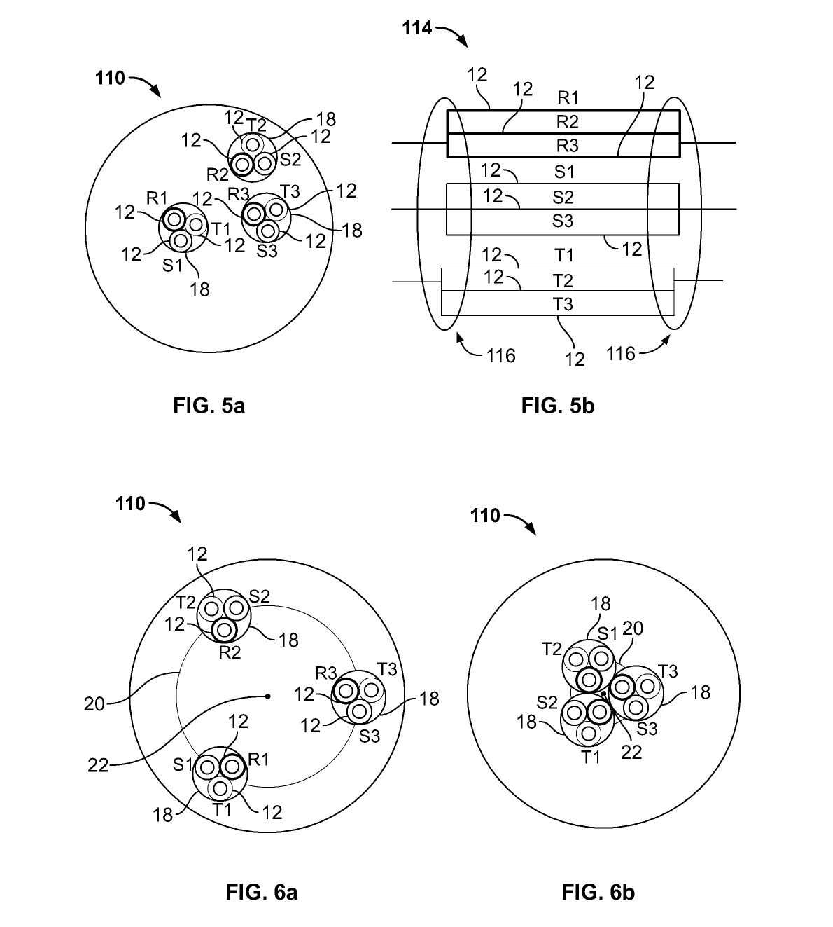

Referring to FIG. 5, a second embodiment of an umbilical 110 in accordance with the invention is shown depicting the arrangement of the power cables 12 therein. Only the power cables 12 are shown for clarity. The umbilical 110 is in the form of a subsea power umbilical.

The reference numerals for similar features of the second embodiment to those of the first embodiment have been increased by 100 for convenience, while the same reference numerals have been used for identical features. For example, the terminations which were indicated by the reference numeral 16 in the first embodiment are now indicated by the reference numeral 116.

The second embodiment differs from the first embodiment in that the first independent 3-phase power supply circuit 114 comprises at nine power cables 12 and each phase R, S, T of the 3-phase power supply circuit consists of three power cables 12 connected in parallel with each other as shown in FIG. 5b.

The power cables 12 are shown connected in parallel within the terminations 116 of the umbilical 110.

The power cables 12 are bundled together in triplex formation for power distribution to form power cable triads 18 as shown in FIG. 5a. The nine power cables 12 produce three power cable triads 18. The first power cable triad 18 comprises three phases R1, S1, T1, the second power cable triad 18 comprises three phases R2, S2, T2, and the third power cable triad 18 comprises three phases R3, S3, T3.

Each power cable triad 18 consists of three insulated power cables 12 twisted together.

Referring to FIGS. 6a and 6b, alternative arrangements of the power cables 12 in an umbilical 110 in accordance with the second embodiment of the invention are shown.

As in the earlier described embodiment, the umbilical 110 comprises nine power cables 12 bundled together to form two power cable triads 18. The arrangements of FIGS. 6a and 6b differ from that of FIG. 5 in that the triads 18, and hence the power cables 12, are symmetrically arranged within the umbilical 110.

The triads 18 are arranged symmetrically in the umbilical cross-section at regular angular intervals along first and second imaginary circles 20 having different radii in FIGS. 6a and 6b respectively, and each centered on a main longitudinal axis 22 of the umbilical 110.

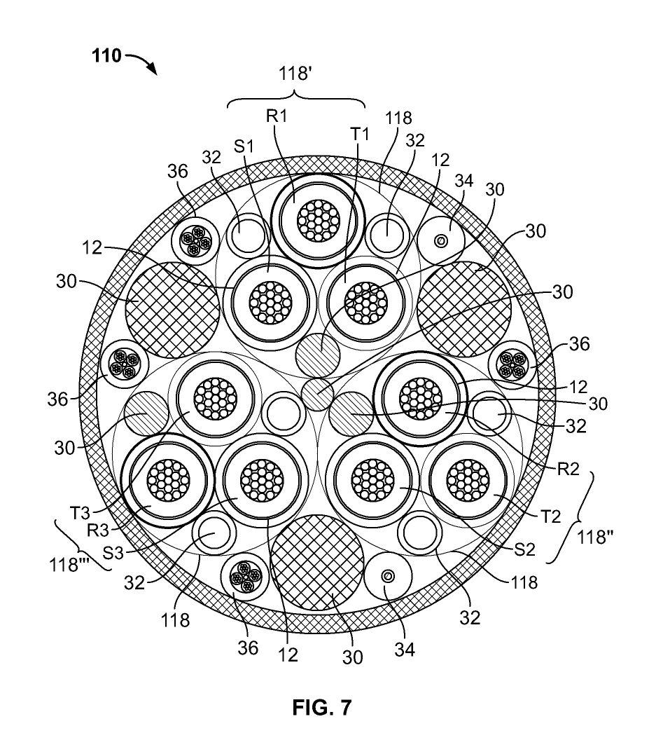

Referring to FIG. 7, a cross-sectional view of the umbilical 110 in accordance with the second embodiment of the invention is shown indicating an exemplary arrangement of the power cable triads now labelled 118 relative to other umbilical elements of the umbilical 110.

The first, second and third triads 118 are indicated by reference numerals 118′, 118″ and 118′″ for clarity.

The three triads 118′, 118″ and 118′″ are preferably identical, which means that the nine power cables 12 are also preferably identical and assembled together

In addition to the power cables 12 arranged in triads, the umbilical also comprises a plurality of polymer fillers 30, thermoplastic hoses or steel tubes 32, optical fibre cables 34 and signal cables 36.

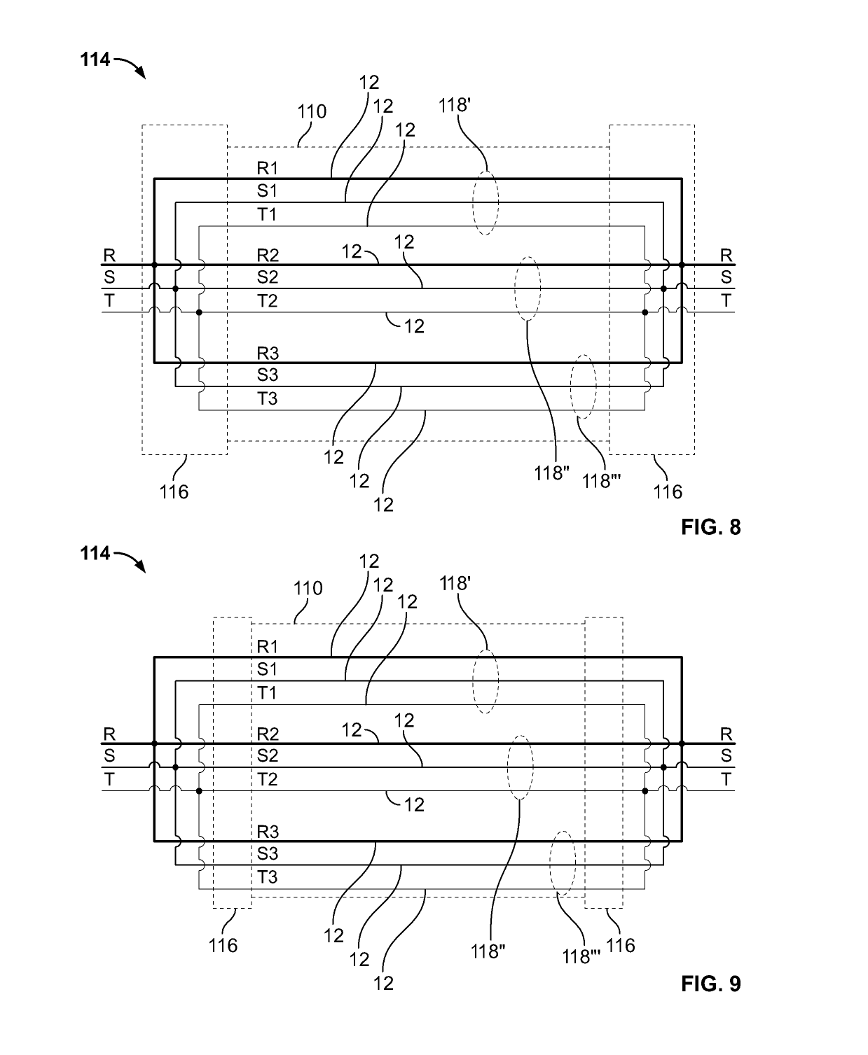

FIGS. 8 and 9 depict the power supply circuit diagram of the umbilical 110 of FIG. 7 showing two possible connections of power cables 12 in the circuit. FIG. 8 depicts the connection of power cables 12 within the terminations 116 of the umbilical 110, while FIG. 9 depicts the connection of the power cables outside the terminations of the umbilical 110.

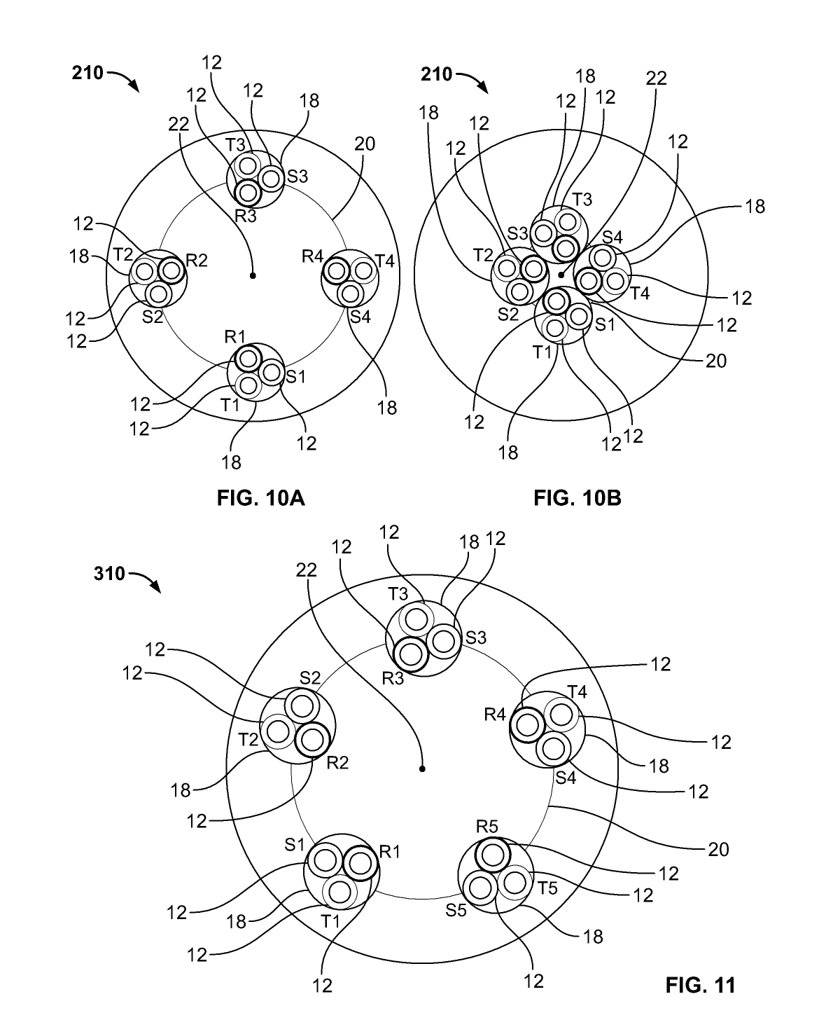

Referring to FIGS. 10A and 10B, arrangements of the power cables 12 in an umbilical 210 in accordance with a third embodiment of the invention are shown.

The umbilical 210 comprises twelve power cables 12 forming a single independent 3-phase power supply circuit.

In the arrangements shown, the power cables 12 are bundled together to form power cable triads 18, in this case four power cable triads.

The triads 18, and hence the power cables 12, are shown symmetrically arranged within the umbilical 210 at regular angular intervals along first and second imaginary circles 20 having different radii in FIGS. 10A and 10B respectively, and each centered on a main longitudinal axis 22 of the umbilical 210.

It would be understood that the power cables 12 are not required to be symmetrically arranged within the umbilical 210.

Referring to FIG. 11, an arrangement of the power cables 12 in an umbilical 310 in accordance with a fourth embodiment of the invention is shown.

The umbilical 310 comprises fifteen power cables 12 forming a single independent 3-phase power supply circuit.

In the arrangements shown, the power cables 12 are bundled together to form power cable triads 18, in this case five power cable triads 18.

The triads 18, and hence the power cables 12, are shown symmetrically arranged within the umbilical 310 at regular angular intervals along an imaginary circle 20 centered on a main longitudinal axis 22 of the umbilical 310.

It would be understood that the power cables 12 are not required to be symmetrically arranged within the umbilical 310.

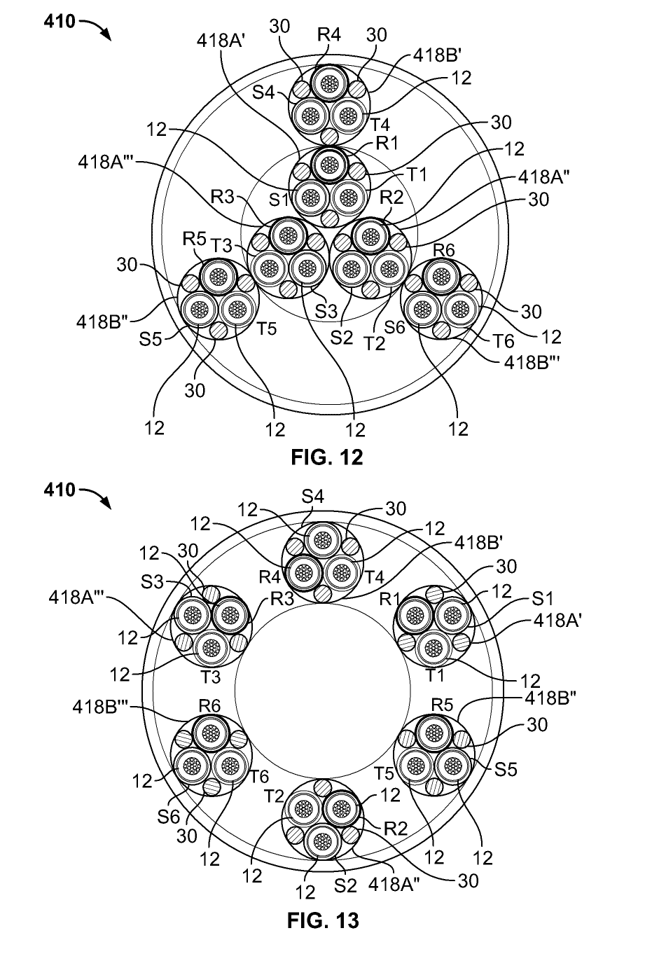

Referring to FIG. 12, a cross-sectional view of an umbilical 410 in accordance with a fifth embodiment of the invention is shown. Only the triads 418 are shown for clarity.

The reference numerals for similar features of the fifth embodiment to those of the second embodiment have been increased by 300 for convenience, while the same reference numerals have been used for identical features. For example, the power cable triads which were indicated by the reference numeral 118 in the second embodiment are now indicated by the reference numeral 418.

It would be understood that while the power cable triads 418 are shown with power cables 12 and polymer fillers 30, one or more of the polymer fillers 30 may be replaced by a thermoplastic hose, steel tube or other component.

The fifth embodiment differs from the earlier described embodiments in that rather having a single independent 3-phase power supply circuit, the umbilical 410 comprises two independent 3-phase power supply circuits.

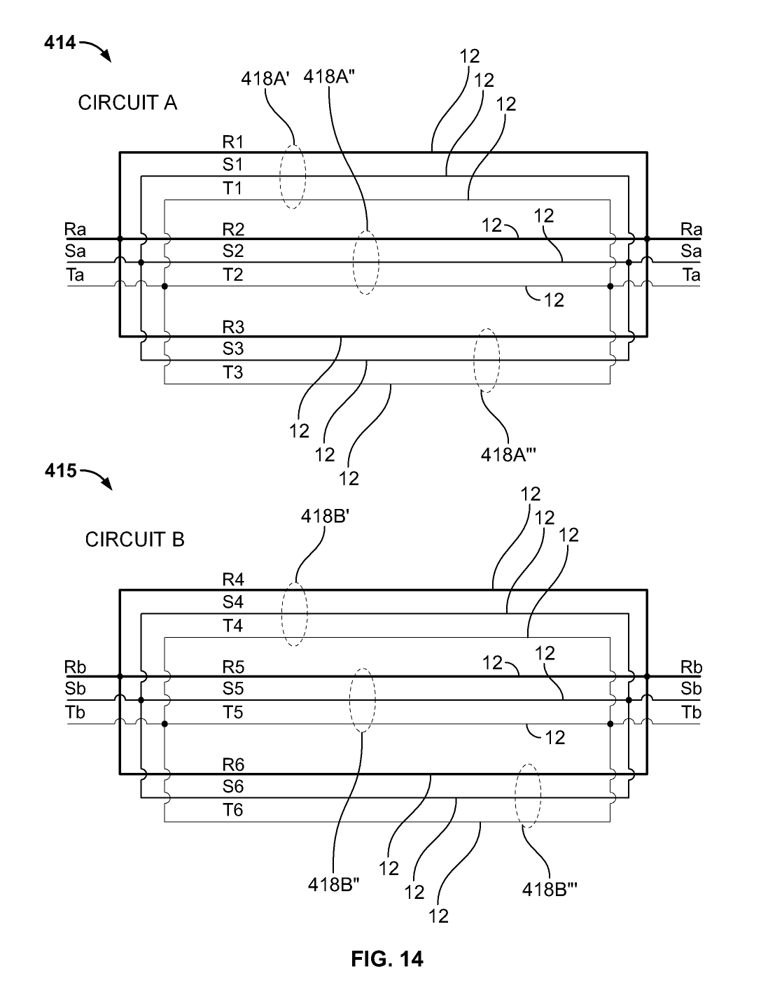

In the arrangement shown in FIG. 12, a first independent 3-phase power supply circuit (414 shown in FIG. 14 and described hereinafter) is similar to that described above in relation to the second embodiment of the invention, and comprises nine power cables 12 bundled to form three triads 418A′, 418A″, 418A′″ It would be understood that the first independent 3-phase power supply circuit may instead be similar to that described above in relation the first, third or fourth embodiments.

A second independent 3-phase power supply circuit (415 shown in FIG. 14 and described hereinafter), is similar to that of the first independent 3-phase power supply circuit 414, and comprises at least six power cables 12 wherein each phase of the second 3-phase power supply circuit 415 consists of at least two power cables 12 connected in parallel with each other.

In the arrangement shown in FIG. 12, the second independent 3-phase power supply circuit 415 is similar to that described above in relation to the second embodiments, and comprises nine power cables 12 bundled to form three triads 418B′, 418B″, 418B′″. It would be understood that the second independent 3-phase power supply circuit may instead be similar to that described above in relation to the first, third or fourth embodiments.

Also, whilst the first and second 3-phase power supply circuits 414, 415 are shown as both having nine power cables 12, they are not limited to having the same number of power cables 12. Furthermore, the cables 12 of the first and second 3-phase power circuits 414, 415 may not be identical. For example, the first 3-phase power circuit 414 may comprise nine cables of cross-section 50 mm² each, and the second 3-phase power circuit 415 may comprise six cables of cross-section 90 mm² each.

In FIG. 12, the triads 418 are depicted arranged symmetrically in the umbilical cross-section at regular angular intervals along two different imaginary circles centered on a main longitudinal axis (not shown) of the umbilical 410.

The first and second independent 3-phase power supply circuits 414, 415 are arranged so as to define an inner circuit or ‘Circuit A’ shown in the top or first part of FIG. 14, and an outer circuit or ‘Circuit B’, shown in the bottom or second part of FIG. 14, respectively within the umbilical 410. The inner and outer circuits may be contra-helically laid. Alternatively, the inner and outer circuits may be helically laid in the same direction, but with different helix angles.

The first, second and third triads 418 of the first 3-phase power supply circuit are indicated by reference numerals 418A′, 418A″ and 418A′″ for clarity. Similarly, the first, second and third triads 418 of the second 3-phase power supply circuit are indicated by reference numerals 418B′, 418B″ and 418B′″ for clarity.

Referring to FIG. 13, an alternative arrangement of the triads 418 in an umbilical 410 in accordance with the fifth embodiment of the invention is shown.

The arrangement differs from that of FIG. 12 in that the first and second independent 3-phase power supply circuits 414, 415 are not arranged to define an inner circuit and an outer circuit within the umbilical 410, but spaced at regular intervals around a single imaginary circle (not shown).

FIG. 14 depicts the power supply circuit diagram of the umbilical 410 in accordance with the fifth embodiment of the invention. As in the earlier described embodiments, the power cables 12 may be connected in parallel within one of the terminations of the umbilical 410, within both terminations of the umbilical 410 or outside the terminations of the umbilical 410. The first independent 3-phase power supply circuit 414 comprises the first triads 418A′, 418A″ and 418A′″, and the second independent 3-phase power supply circuit 415 comprises the triads 418B′, 418B″ and 418B′″.

In accordance with a sixth embodiment (not shown), the umbilical comprises three or more independent 3-phase power supply circuits. Each independent power supply circuit may comprise at least six power cables wherein each phase of the 3-phase power supply circuit consists of at least two power cables connected in parallel with each other.

The arrangement of the power cables forming each independent 3-phase power supply circuits may be in accordance with the first, second, third or fourth embodiments described earlier.

In addition, the independent 3-phase power supply circuits may be arranged so as to define an outer circuit and an inner circuit within the umbilical; an outer circuit, a middle circuit and an inner circuit within the umbilical or other suitable arrangement.

The present invention can be easily implemented with the existing manufacturing technology.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An umbilical comprising a first independent 3-phase power supply circuit, the power supply circuit comprising at least six power cables wherein each phase of the 3-phase power supply circuit consists of at least two power cables connected in parallel with each other.

2. An umbilical according to claim 1, wherein the umbilical further comprises a second independent 3-phase power supply circuit.

3. An umbilical according to claim 2, wherein the second 3-phase power supply circuit comprises at least six power cables wherein each phase of the second 3-phase power supply circuit consists of at least two power cables connected in parallel with each other.

4. An umbilical according to claim 1, wherein the umbilical comprises three or more independent 3-phase power supply circuits.

5. An umbilical according to claim 4, wherein each independent power supply circuit comprises at least six power cables wherein each phase of the 3-phase power supply circuit consists of at least two power cables connected in parallel with each other.

6. An umbilical according to claim 1, wherein three of the at least six power cables are bundled together in triplex formation for power distribution to form a power cable triad.

7. An umbilical according to claim 6, wherein all of the power cables are bundled together in triplex formation for power distribution to form power cable triads.

8. An umbilical according to claim 6, wherein the umbilical comprises at least three power cable triads defining the first independent power supply circuit.

9. An umbilical according to claim 6, wherein the umbilical further comprises a second independent 3-phase power supply circuit and each independent power supply circuit comprises at least three power cable triads.

10. An umbilical according to claim 6, wherein each triad consists of 3 insulated power cables twisted together.

11. An umbilical according to claim 7, wherein the triads are symmetrically arranged within the umbilical.

12. An umbilical according to claim 11, wherein the triads are arranged symmetrically in the umbilical cross-section.

13. An umbilical according to claim 11, wherein the triads defining at least one independent power supply circuit are arranged at regular angular intervals along an imaginary circle centered on a main longitudinal axis of the umbilical.

14. An umbilical according to claim 13, wherein the triads defining each independent power supply circuit are arranged at regular angular intervals along an imaginary circle centered on a main longitudinal axis of the umbilical.

15. An umbilical according to claim 2, wherein the first and second independent power circuits are arranged to as to define an outer circuit and an inner circuit within the umbilical.

16. An umbilical according to claim 15, wherein the outer circuit and the inner circuit are contra-helically laid.

17. An umbilical according to claim 1, wherein the power cables are connected in parallel in at least one termination of the umbilical.

18. An umbilical according to claim 17, wherein the power cables are connected in parallel in both terminations of the umbilical.

19. An umbilical according to claim 1, wherein the power cables are connected in parallel outside both terminations of the umbilical.

20. An umbilical according to claim 1, wherein the umbilical is a subsea power umbilical.
